(19) United States
(12) Patent Application Publication
(10) Pub. No.: US 2023/0320374 A1
(43) Pub. Date: Oct. 12, 2023

(54) BONE CONDUCTION VIBRATION SOUNDING CANDY AND A SOUNDING CONTROL METHOD AND CONTROL SYSTEM THEREOF

(71) Applicant: Beijing Donglin Huarui Commerce & Trade Co., Ltd., Beijing (CN)

(72) Inventors: Chun YU, Beijing (CN); Liang CHEN, Beijing (CN)

(73) Assignee: Beijing Donglin Huarui Commerce & Trade Co., Ltd., Beijing (CN)

(21) Appl. No.: 17/662,846

(22) Filed: May 10, 2022

(30) Foreign Application Priority Data
Apr. 12, 2022 (CN) 202210384096.0
Apr. 12, 2022 (CN) 202220845131.X

(51) Int. Cl. A23G 3/56; H04R 1/10

(52) U.S. Cl. CPC A23G 3/563; H04R 1/1066; H04R 1/1091; H04R 2460/13

(57) ABSTRACT

The present invention discloses a bone conduction vibration sounding candy, a sounding control method, and a sounding control system. The candy is used for bone conduction vibration sounding. A system end is only used as a medium for a bone conduction playback end to obtain a readable sound file, and does not interfere with music playback of the bone conduction playback end. An identification two-dimensional code of the bone conduction playback end serves as a medium for rapid authentication and information transmission, so that one system end corresponds to a plurality of bone conduction playback ends, and the bone conduction playback ends do not interfere with each other. Moreover, a variety of readable music files can meet different requirements of users.

### BACKGROUND

### Technical Field

The present invention relates to the field of bone conduction technologies, and specifically, to a bone conduction vibration sounding candy, and a control method and a control system for implementing bone conduction vibration sounding of the candy.

### Related Art

Among many optional snacks, candies are very popular. At present, there are many kinds of candies on the market, among which bone conduction music lollipops begin to be widely welcomed by people. The working principle of a bone conduction music lollipop is to transmit sound through bone conduction, that is, transmit sound to the auditory ossicles through the bite of the candy with the teeth and bones in the oral cavity, so that people can listen to the sound while eating the candy, to enjoy the novel experience brought by the lollipop to both the taste buds and the hearing sense.

In the Chinese patent application with the publication number CN112543403A, a bone conduction Bluetooth music lollipop is disclosed, including a handle box and a candy body. A circuit board is arranged inside the handle box. A bone conduction drive chip is arranged on the circuit board. A vibrator is fixed to one end of the circuit board. A vibrator clip is arranged on each of a top portion and a bottom portion of the vibrator. A conductive metal sheet is arranged on the other end of the vibrator clip. The candy body includes a candy bar, a candy block, and a pluggable connector. The pluggable connector is inserted into an end portion of the handle box. The candy block is fixed to the pluggable connector, so that the candy block and the handle box form a replaceable split structure. Therefore, the flavor of the lollipop can be changed at any time, and the handle box can be cyclically used, which is economical and practical. The lollipop is connected to a mobile phone through a Bluetooth module, so that audio played by the lollipop can be customized and replaced, and people can listen to the sound as needed while eating the candy, to better enjoy the novel experience brought by the lollipop to both the taste buds and the hearing sense.

However, the foregoing technical solution still has the following problems: First, the sound played through the bone conduction vibrator comes into contact with the mastoid behind the ear through Bluetooth. People can hear the sound in this way. However, if people need to hear sound information generated from the vibrator clearly, it needs to be ensured that the bone conduction vibrator maintains a certain connection pressure with the mastoid behind the ear. However, prolonged pressure on the mastoid behind the ear can cause skin redness and swelling, inflammation, and even damage in severe cases. Second, the transmission through Bluetooth can only be one-to-one transmission, not for multi-point transmission simultaneously. Third, the mobile phone needs to be connected for online playback, so that the lollipop cannot be used without the mobile phone.

### SUMMARY

A primary technical problem to be resolved in the present invention is to provide a bone conduction vibration sounding candy, which can improve the use effect.

Another technical problem to be resolved in the present invention is to provide a control method for bone conduction vibration sounding of the candy.

Still another technical problem to be resolved in the present invention is to provide a control system for bone conduction vibration sounding of the candy.

To achieve the foregoing objectives, the present invention adopts the following technical solutions:

According to a first aspect of the embodiments of the present invention, a bone conduction vibration sounding candy is provided, including:
a bone conduction playback end, having a unique identification two-dimensional code, for a system end to perform identification and transmit a preselected readable sound file according to an identification result for sound playback; and
a candy body, arranged on the bone conduction playback end for chewing.

Preferably, the bone conduction playback end includes:
a holding portion, where the unique identification two-dimensional code is arranged on the holding portion, and the holding portion has an accommodating cavity;
a circuit control portion, accommodated in the accommodating cavity and configured to be wirelessly connected to the system end, to receive the preselected readable sound file and convert the preselected readable sound file into an amplified analog sound signal; and
a bone conduction vibrator, connected to the circuit control portion through a wire and configured to output the amplified analog sound signal.

Preferably, the bone conduction vibrator is fixed in the holding portion and wrapped by the candy body; and
an end of the holding portion for fixing the bone conduction vibrator has a spherical or columnar expansion portion, and the expansion portion has a preset size to be suitable for oral chewing.

Preferably, a hardness of the expansion portion is more than 10 degrees Shore.

Preferably, an outer diameter of the expansion portion is a size suitable for oral chewing.

Preferably, the candy body is a sugar-free food or is a thin sugar-containing food with a thickness of 3 mm or less.

Preferably, the circuit control portion includes:
a control circuit board, accommodated in the accommodating cavity for circuit control;
an input portion, connected to the control circuit board and configured to be wirelessly connected to the system end, to receive the readable sound file;
a second read-write memory, connected to the control circuit board and the input portion, and configured to store the readable sound file;
a second decoding portion, connected to the control circuit board and the second read-write memory, and configured to decode the readable sound file into a digital audio file;
a digital-to-analog conversion portion, connected to the control circuit board and the second decoding portion, and configured to convert the digital audio file into an analog sound signal;
a power amplifier, connected to the control circuit board and the digital-to-analog conversion portion, and configured to amplify the analog sound signal; and
a power supply, connected to the control circuit board and configured to supply power to the control circuit board.

Preferably, the circuit control portion has adjustable power supply compartments for placing power supplies with different power levels, and the power levels are determined according to a duration of sound playback by the bone conduction playback end.

Preferably, the circuit control portion has a plurality of power supply compartments, the power supplies are placed in the power supply compartments, and the power supplies in the plurality of power supply compartments are connected in series or independent of each other.

Preferably, the plurality of power supply compartments have different sizes for respectively placing power supplies of different sizes.

According to a second aspect of the embodiments of the present invention, a control method for bone conduction vibration sounding is provided, implemented based on the foregoing bone conduction vibration sounding candy. The method includes the following steps:
scanning a two-dimensional code sound file through a system end, to generate a readable sound file and store the readable sound file in the system end;
scanning a unique identification two-dimensional code on a bone conduction playback end through the system end, to transmit the selected readable sound file to the bone conduction playback end; and
receiving the readable sound file through the bone conduction playback end, and playing music after data conversion.

Preferably, the scanning a two-dimensional code sound file through a system end, to generate a readable sound file and store the readable sound file in the system end further includes:
reading the two-dimensional code sound file through a two-dimensional code reading portion of the system end;
receiving the two-dimensional code sound file through a first read-write memory of the system end, and temporarily storing the two-dimensional code sound file in the first read-write memory;
obtaining the temporarily stored two-dimensional code sound file from the first read-write memory through a first decoding portion of the system end, to perform data decoding on the temporarily stored two-dimensional code sound file and generate the readable sound file;
feeding back the readable sound file to the first read-write memory through the first decoding portion; and
obtaining the readable sound file through a display portion of the system end, to display the readable sound file in a data list.

Preferably, the receiving the readable sound file through the bone conduction playback end, and playing music after data conversion further includes:
receiving the readable sound file through an input portion of the bone conduction playback end;
obtaining, through a second read-write memory of the bone conduction playback end, the readable sound file sent by the input portion, and storing the readable sound file in the second read-write memory;
obtaining the readable sound file in the second read-write memory through a second decoding portion of the bone conduction playback end, and decoding the readable sound file into a digital audio file;
obtaining the digital audio file through a digital-to-analog conversion portion of the bone conduction playback end, and converting the digital audio file into an analog sound signal;
obtaining the analog sound signal through a power amplifier of the bone conduction playback end, and amplifying the analog sound signal; and
receiving the amplified analog sound signal through a bone conduction vibrator of the bone conduction playback end, and outputting the analog sound signal.

According to a third aspect of the embodiments of the present invention, a bone conduction vibration sounding system is provided, including:
a system end, configured to identify a two-dimensional code sound file, to generate a readable sound file and store the readable sound file in the system end;
a bone conduction playback end, having a unique identification two-dimensional code, for the system end to perform identification and transmit a preselected readable sound file according to an identification result for music playback; and
a candy body, arranged on the bone conduction playback end for chewing.

Preferably, the bone conduction playback end includes:
a holding portion, where the unique identification two-dimensional code is arranged on the holding portion, and the holding portion has an accommodating cavity;
a circuit control portion, accommodated in the accommodating cavity and configured to be wirelessly connected to the system end, to receive the preselected readable sound file and convert the preselected readable sound file into an amplified analog sound signal; and
a bone conduction vibrator, connected to the circuit control portion through a wire and configured to output the amplified analog sound signal.

Preferably, the bone conduction vibrator is fixed in the holding portion and wrapped by the candy body; and
an end of the holding portion for fixing the bone conduction vibrator has a spherical or columnar expansion portion, and the expansion portion has a preset size to be suitable for oral chewing.

Preferably, a hardness of the expansion portion is more than 10 degrees Shore.

Preferably, an outer diameter of the expansion portion is a size suitable for oral chewing.

Preferably, the candy body is a sugar-free food or is a thin sugar-containing food with a thickness of 3 mm or less.

Preferably, the circuit control portion has adjustable power supply compartments for placing power supplies with different power levels, and the power levels are determined according to a duration of sound playback by the bone conduction playback end.

Compared with the prior art, the present invention has the following technical effects:
(1) A variety of readable music files are pre-stored in the system end, which is only used as a medium for the bone conduction playback end to obtain the readable sound file, and does not interfere with the music playback of the bone conduction playback end. Moreover, the variety of readable music files can meet different requirements of users.
(2) Each bone conduction playback end has a unique identification two-dimensional code, so that the identification two-dimensional code can be used as a medium for rapid authentication and information transmission, and a plurality of bone conduction playback ends can respectively obtain required readable sound files. That is, one system end corresponds to a plurality of bone conduction playback ends, and the bone conduction playback ends do not interfere with each other.
(3) The expansion portion is arranged on the holding portion. The material of the expansion portion is a material that is harmless to the human body, does not damage the teeth, and is chewable. The expansion portion enables a consumer to continue to chew the expansion portion to implement sound playback after eating the small volume of candy body (for example, a thin layer of candy body). Therefore, the consumer can reduce sugar intake, which is beneficial to body health.
(4) With the design of the expansion portion, the expansion portion can withstand chewing for a long time (more chewy than the candy body of the same volume). Therefore, the plurality of power supply compartments are arranged on the circuit control portion, and power supplies of different capacities may be matched according to requirements, to implement sound playback for a long time or a short time, thereby meeting requirements of different consumers.

### BRIEF DESCRIPTION OF THE DRAWINGS

FIG. 1 is a schematic diagram of an overall structure of a bone conduction vibration sounding candy according to a first embodiment of the present invention;

FIG. 2 is a flowchart of forming and using a two-dimensional code sound file in the first embodiment of the present invention;

FIG. 3 is a schematic diagram of an internal structure of a system end according to the first embodiment of the present invention;

FIG. 4 is a schematic diagram of a disassembled structure of the bone conduction vibration sounding candy according to the first embodiment of the present invention;

FIG. 5 is a schematic diagram of a specific structure of a circuit control portion in FIG. 4;

FIG. 6 is a flowchart of a control method for bone conduction vibration sounding according to the first embodiment of the present invention; and

FIG. 7 is a schematic diagram of an overall structure of a bone conduction vibration sounding candy according to a second embodiment of the present invention.

### DETAILED DESCRIPTION

The technical content of the present invention is described in detail below with reference to the accompanying drawings and specific embodiments.

### First Embodiment

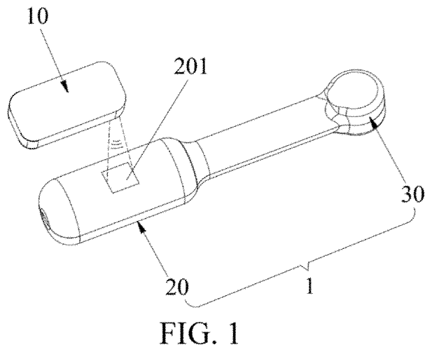

FIG. 1 shows a bone conduction vibration sounding candy 1 provided in an embodiment of the present invention. An action of chewing a candy in an oral cavity by a user enables the user to hear sound in the ears. For the convenience of description, the bone conduction vibration sounding candy is used as an example for description in this embodiment of the present invention, but this does not constitute a limitation on the present invention. Therefore, the bone conduction vibration sounding candy in this embodiment of the present invention may be understood as an object with a predetermined hardness that is edible in the oral cavity such as food or medicine.

The bone conduction vibration sounding candy 1 provided in this embodiment of the present invention includes a bone conduction playback end 20 and a candy body 30. The bone conduction playback end 20 is configured for information exchange with a system end 10.

The system end 10 is configured to identify a two-dimensional code sound file, to generate a readable sound file and store the readable sound file in the system end 10. The bone conduction playback end 20 has a unique identification two-dimensional code 201, for the system end 10 to identify the identification two-dimensional code 201 and transmit a preselected readable sound file to the bone conduction playback end 20 for music playback. The identification two-dimensional code 201 may be alternatively replaced by a wireless reading device such as a radio frequency transmitter, but such a design increases the costs and is not suitable for one-time use.

The candy body is a sphere, and is wrapped outside the bone conduction playback end 20 for consumption. In a preferred embodiment of the present invention, the candy body 30 is preferably a hard candy such as a lollipop (but without a small wooden stick of a lollipop), and certainly, may be in other forms, for example, a candy made from chocolate mixed with nut granules. A food (for example, a lollipop or nut) with a relatively large hardness has a better sound playback effect than a food (for example, bread or pudding) with a relatively small hardness.

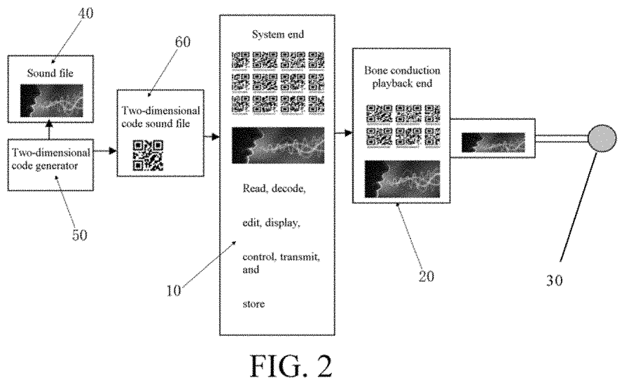

As shown in FIG. 2, in an embodiment of the present invention, a two-dimensional code sound file 60 is formed by combining a sound file 40 with a two-dimensional code generator 50. The system end 10 is used as a carrier of the two-dimensional code sound file 60. A plurality of different two-dimensional code sound files 60 may be identified as different readable sound files for storage, which may then be used as a music playback library of the bone conduction playback end 20. The bone conduction playback end 20 has a unique identification two-dimensional code 201. The system end 10 scans the identification two-dimensional code 201 to transmit a readable sound file selected by the user in the music playback library to the bone conduction playback end 20 for music playback.

It may be understood that in this process, the system end 10 is only used as a medium for the bone conduction playback end 20 to obtain the readable sound file. After the bone conduction playback end 20 obtains the readable sound file, the system end 10 does not interfere with the music playback of the bone conduction playback end 20. Moreover, the identification two-dimensional code 201 of the bone conduction playback end 20 is used as a medium for fast authentication and information transmission. Different bone conduction playback ends 20 have different identification two-dimensional codes 201. A plurality of bone conduction playback ends 20 may respectively obtain required readable sound files simultaneously, so that one system end 10 corresponds to the plurality of bone conduction playback ends 20, and the bone conduction playback ends 20 do not interfere with each other.

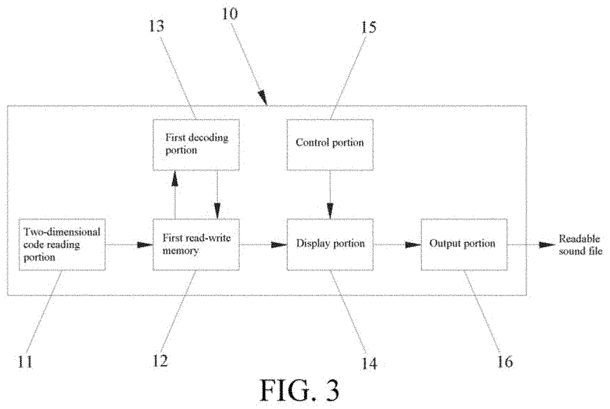

In the foregoing embodiment, the system end includes, but is not limited to, a mobile phone with a preset APP. The preset APP is APP software compiled by using Java and OC. Functions such as reading, decoding, editing, displaying, controlling, transmission, and storage are written in the software. As shown in FIG. 3, in an embodiment of the present invention, the system end 10 includes: a two-dimensional code reading portion 11, a first read-write memory 12, a first decoding portion 13, a display portion 14, a control portion 15, and an output portion 16.

Specifically, the two-dimensional code reading portion 11 scans a two-dimensional code sound file to read the two-dimensional code sound file.

The first read-write memory 12 is connected to the two-dimensional code reading portion 11, and is configured to temporarily store a two-dimensional code sound file sent by the two-dimensional code reading portion 11.

The first decoding portion 13 is connected to the first read-write memory 12, and is configured to perform data exchange with the first read-write memory 12. The data exchange includes: obtaining the temporarily stored two-dimensional code sound file from the first read-write memory through the first decoding portion 13, and performing data decoding to generate a readable sound file; and feeding back the readable sound file to the first read-write memory through the first decoding portion 13. It may be understood that what the first read-write memory 12 obtains from the two-dimensional code reading portion 11 is the two-dimensional code sound file (existing in the form of a two-dimensional code), which is then temporarily stored in the first read-write memory 12 after being obtained. The first decoding portion 13 is used to perform data exchange with the first read-write memory 12, thereby decoding the two-dimensional code sound file temporarily stored in the first read-write memory 12 into the readable sound file (existing in the form of a non-two-dimensional code).

The display portion 14 is connected to the first read-write memory 12, and is configured to display the readable sound file in a data list. Content of the list may include information such as a song name, a singer, and a playback time.

The control portion 15 is connected to the display portion 14, and is configured to input a control instruction to the display portion 14. The control instruction is an instruction inputted by the user through an operation interface of the control portion 15, and is, for example, clicking to play a song or deleting a song.

The output portion 16 is connected to the display portion 14, and is configured to obtain a selected readable sound file from the data list according to the control instruction, and output the readable sound file to the bone conduction playback end 20. When the user clicks to play a song through the operation interface of the control portion 15, the output portion 16 obtains the readable sound file selected by the user (that is, the song clicked by the user), and then transmits the readable sound file to the bone conduction playback end 20 through Wi-Fi wireless transmission for music playback.

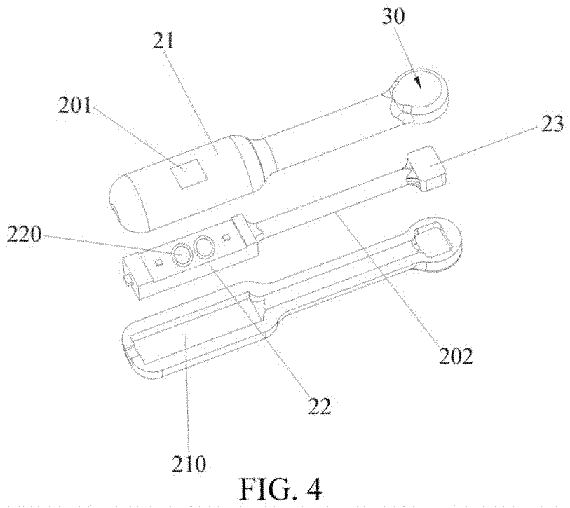

As shown in FIG. 4, in an embodiment of the present invention, the bone conduction playback end 20 includes: a holding portion 21, a circuit control portion 22, and a bone conduction vibrator 23. The unique identification two-dimensional code 201 is arranged on the holding portion 21, and the holding portion 21 (shown as an upper and lower split structure in the figure) has an accommodating cavity 210 for accommodating and fixing the circuit control portion 22 and the bone conduction vibrator 23. The circuit control portion 22 is accommodated in the accommodating cavity 210, and is wirelessly connected to the output portion 16 to receive the readable sound file selected by the user and convert the readable sound file into an amplified analog sound signal. The bone conduction vibrator 23 is controlled according to the analog sound signal. The bone conduction vibrator 23 is connected to the circuit control portion 22 through a wire and located outside the accommodating cavity 210, and is configured to convert the analog sound signal into vibration (that is, play music).

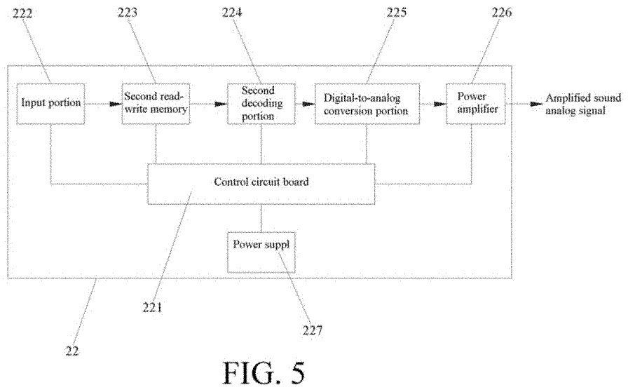

As shown in FIG. 5, in the foregoing embodiment, the circuit control portion 22 includes: a control circuit board 221, an input portion 222, a second read-write memory 223, a second decoding portion 224, a digital-to-analog conversion portion 225, a power amplifier 226, and a power supply 227.

Specifically, the control circuit board 221 is accommodated in the accommodating cavity 210 and is configured to control the input portion 222, the second read-write memory 223, the second decoding portion 224, the digital-to-analog conversion portion 225, and the power amplifier 226.

The input portion 222 is connected to the control circuit board 221. The input portion 222 is wirelessly connected to the output portion 16 and is configured to receive the readable sound file. In this embodiment of the present invention, the input portion 222 and the output portion 16 are connected through Wi-Fi to transmit the readable sound file. The advantages of using Wi-Fi for file transmission are that the format of the transmitted file is not distorted, and the speed of transmitting the file can be ensured. In addition, multi-point transmission (that is, one system end 10 corresponds to a plurality of bone conduction playback ends 20) may be further performed, and the connection is fast. It may be understood that in other embodiments, the input portion 222 and the output portion 16 may be alternatively connected in other wireless connection manners to transmit the readable sound file, for example, Bluetooth connection.

The second read-write memory 223 is connected to the control circuit board 221 and the input portion 222, and is configured to store the readable sound file.

The second decoding portion 224 is connected to the control circuit board 221 and the second read-write memory 223, and is configured to decode the readable sound file into a digital audio file.

The digital-to-analog conversion portion 225 is connected to the control circuit board 221 and the second decoding portion 224, and is configured to convert the digital audio file into a analog sound signal.

The power amplifier 226 is connected to the control circuit board 221 and the digital-to-analog conversion portion 225, and is configured to amplify the analog sound signal. As a result, the readable sound file is converted into the amplified analog sound signal through the second decoding portion 224, the digital-to-analog conversion portion 225, and the power amplifier 226 sequentially. The bone conduction vibrator 23 is connected to the power amplifier 226 through a wire 202, to receive the amplified analog sound signal, and implement sound playback through vibration.

The power supply 227 is connected to the control circuit board 221 and is configured to supply power to the control circuit board 221. In this embodiment of the present invention, the power supply 227 is a button battery (for example, a disposable lithium carbon fluoride Li—(CFx) n button power supply or a lithium-manganese oxide button power supply), and the specific type of the power supply 227 is not limited and may be adaptively selected according to requirements. The capacity of the power supply 227 is related to the volume of the candy body 30. Generally, a larger volume of the candy body 30 indicates a longer time for chewing the candy body 30 and a larger power level required, and thus indicates a larger volume of the power supply (the same type of power supply).

As shown in FIG. 4, the circuit control portion 22 has adjustable power supply compartments for placing power supplies with different power levels, and the power levels are determined according to a duration of sound playback by the bone conduction playback end. In the embodiment shown in FIG. 4, the adjustable power supply compartments are two power supply compartments 220 connected in series (two power supplies placed in the two power supply compartments form a series connection) for accommodating the power supplies 227. In the figure, the power supplies 227 are two button batteries, and are respectively placed in the two power supply compartments 220. According to the volume of the candy body 30, only one power supply 227 may be placed in one power supply compartment; or the power supply 227 may be placed in each of the power supply compartments 220 to provide more power and a longer sound playback time. It may be understood that, to reduce the costs and the volume of the bone conduction vibration sounding candy provided in the present invention, it is preferable to form a plurality of series of bone conduction vibration sounding candies. Each series has a different quantity of power supply compartments 220. For example, a bone conduction vibration sounding candy of series I has only one power supply compartment 220, which is configured to install one power supply 227 to meet a requirement of playback for a short time. A bone conduction vibration sounding candy of series II has three power supply compartments 220, which are configured to install three power supplies 227 (the three power supplies are connected in series to form a power supply) to meet a requirement of playback for a long time. It may be understood that, the adjustable power supply compartments may alternatively use a structure such as an elastic piece to be suitable for different button batteries with different sizes. For example, by using a design of a metal elastic piece, a CR2032 button power supply (thicker) with more power or a CR2025 button power supply (thinner) with less power may be placed in the same power supply compartment.

The candy body 30 is wrapped around an outer periphery of an end portion of the holding portion 21 on which the bone conduction vibrator 23 is located, and is of a size that can be swallowed completely, such as a common spherical lollipop, or a flat stick lollipop with a smaller size. A melting time of the candy body 30 in the oral cavity, as a candy body melting time, is determined by the size and the raw material of the candy body. For example, a candy body melting time T of a spherical lollipop in the oral cavity is generally 20 min or less. Therefore, the power supply selected in the present invention is a button power supply, which is sufficient to provide the control circuit board 22 with a time greater than the candy body melting time T. More preferably, the power supply 227 has a power level greater than T and less than 2T. This can ensure that the user can always hear the sound before the candy body 30 completely melts, and the sound does not disappear due to insufficient power. In addition, the volume of the power supply is not large due to excessive capacity of the power supply, thereby implementing the miniaturization and portability (the user does not feel the weight when the candy is in the oral cavity) of the bone conduction vibration sounding candy provided in the present invention. More importantly, the power supply with a small power level has low costs, which is beneficial to meet the one-time use requirement of the bone conduction vibration sounding candy.

In the foregoing embodiment, the candy body 30 is wrapped on the bone conduction vibrator 23 of the bone conduction playback end 20, where the bone conduction vibrator is made of a food-grade safe plastic material. In the process of eating the candy body 30 by the user, music may be played according to a readable sound file selected by the user, thereby improving the user experience.

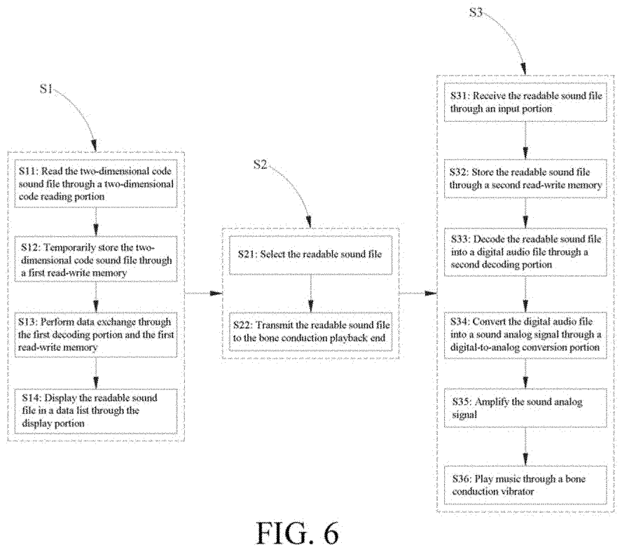

As shown in FIG. 6, based on the foregoing bone conduction vibration sounding candy, an embodiment of the present invention further provides a control method for bone conduction vibration sounding, which further includes steps S1 to S3:

S1: Scan a two-dimensional code sound file through a system end 10, to generate a readable sound file and store the readable sound file in the system end 10.

Specifically, S1 includes steps S11 to S14:

S11: Read the two-dimensional code sound file through a two-dimensional code reading portion 11.

Specifically, the two-dimensional code reading portion 11 may sequentially read a plurality of two-dimensional code sound files, thereby providing a music basis for forming a music library.

S12: Temporarily store the two-dimensional code sound file through a first read-write memory 12.

After the two-dimensional code reading portion 11 reads a two-dimensional code sound file, the first read-write memory 12 receives the two-dimensional code sound file sent from the two-dimensional code reading portion 11, and temporarily store the two-dimensional code sound file in the first read-write memory 12, for a first decoding portion 13 to call.

S13: Perform data exchange through the first decoding portion 13 and the first read-write memory 12.

After the two-dimensional code sound file is temporarily stored in the first read-write memory 12, the first decoding portion 13 performs data exchange with the first read-write memory. The data exchange further includes: First, the first decoding portion 13 obtains the temporarily stored two-dimensional code sound file from the first read-write memory, to perform data decoding on the temporarily stored two-dimensional code sound file and generate the readable sound file. The first decoding portion 13 then feeds back the readable sound file to the first read-write memory 12.

S14: Display the readable sound file in a data list through the display portion 14.

Specifically, after the first decoding portion 13 feeds back the readable sound file to the first read-write memory 12, the first read-write memory 12 stores the readable sound file in the form of a non-two-dimensional code. In this case, the display portion 14 can display the readable sound file. In this embodiment of the present invention, the display manner is a list, each column corresponds to a readable sound file, and the displayed content at least includes information such as a song name, a singer, and a playback time.

S2: Scan a unique identification two-dimensional code 201 on a bone conduction playback end 20 through the system end 10, to transmit the selected readable sound file to the bone conduction playback end 20.

Specifically, S2 includes steps S21 and S22:

S21: Select the readable sound file.

Specifically, the user may input a control instruction through an operation interface of a control portion 15 to select a readable sound file required from the data list of the display portion 14 according to the preference of the user.

S22: Transmit the selected readable sound file to the bone conduction playback end 20.

The readable sound file is obtained through an output portion 16 of the system end, and the unique identification two-dimensional code 201 on the bone conduction playback end is scanned, to transmit the readable sound file to the bone conduction playback end 20 through wireless transmission.

S3: Receive the readable sound file through the bone conduction playback end, and play music after data conversion.

Specifically, S3 includes steps S31 to S36:

S31: Receive the readable sound file through an input portion 222.

Specifically, the input portion 222 is connected to the output portion 16 of the system end through Wi-Fi, and the unique identification two-dimensional code 201 on the bone conduction playback end 20 is scanned through the output portion 16, to transmit the readable sound file selected by the user to the input portion 222 through Wi-Fi wireless transmission.

S32: Store the readable sound file through a second read-write memory 223.

Specifically, after the input portion 222 receives the readable sound file, the input portion 222 sends the readable sound file to the second read-write memory 223. The second read-write memory 223 reads the readable sound file correspondingly and stores the readable sound file in the second read-write memory 223.

S33: Decode the readable sound file into a digital audio file through a second decoding portion 224.

Specifically, after the readable sound file is stored in the second read-write memory 223, the second decoding portion 224 obtains the readable sound file and decodes the readable sound file into the digital audio file.

S34: Convert the digital audio file into a analog sound signal through a digital-to-analog conversion portion 225.

After the readable sound file is decoded into the digital audio file, the digital-to-analog conversion portion 225 obtains the digital audio file and converts the digital audio file into the analog sound signal.

S35: Amplify the analog sound signal.

After the digital audio file is converted into the analog sound signal, a power amplifier 226 of the bone conduction playback end obtains the analog sound signal, and amplifies the analog sound signal.

S36: Play music through a bone conduction vibrator 23.

After the analog sound signal is amplified, the bone conduction vibrator 23 of the bone conduction playback end receives the amplified analog sound signal, and outputs the amplified analog sound signal for music playback.

Therefore, the bone conduction vibration sounding candy of the first embodiment has a miniaturized and light-weight structure, low costs, and is suitable for one-time use. The sound playback effect meets the requirements.

### Second Embodiment

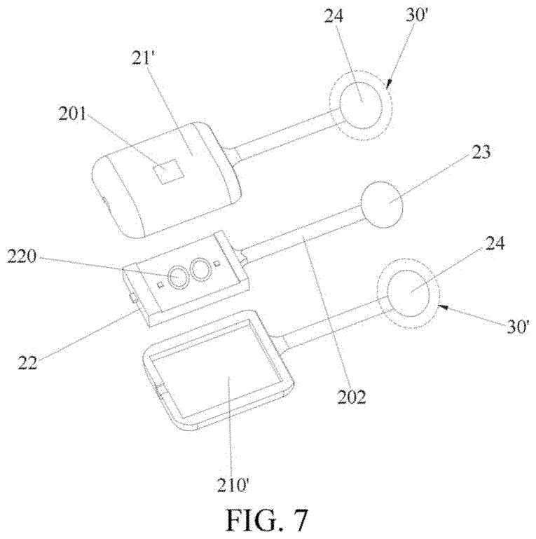

Since the concept of healthy living becomes increasingly popular, reducing the actual intake of sugar is a common demand of the public. As shown in FIG. 7, a bone conduction vibration sounding candy 1′ according to the second embodiment includes a bone conduction playback end 20 and a candy body 30′.

The bone conduction playback end in this embodiment of the present invention is the same as the bone conduction playback end in the first embodiment except for the holding portion, and thus details are not described herein again. The bone conduction playback end 20 includes: a holding portion 21′, a circuit control portion 22, and a bone conduction vibrator 23. A unique identification two-dimensional code 201 is arranged on the holding portion 21′. The bone conduction vibrator 23 is fixed in an accommodating cavity 210′ of the holding portion 21′ and wrapped by the candy body 30′.

The volume of the candy body 30′ in this embodiment of the present invention is smaller than that of the candy body 30 in the first embodiment, and may even be a thin layer, for example, a thin sugar-containing food with a thickness of 3 mm or less. The volume of the candy body 30′ is reduced, so that consumers of the bone conduction vibration sounding candy provided by the present invention can reduce sugar intake. The bone conduction vibration sounding candy provided in this embodiment of the present invention still maintains a sound playback duration while reducing sugar intake.

Therefore, in the bone conduction vibration sounding candy provided in this embodiment of the present invention, an end 21A of the holding portion 21′ for fixing the bone conduction vibrator has a spherical or columnar expansion portion 24. Since the holding portion 21′ is made of a material such as plastic or silica gel, the hardness thereof, measured by a Shore durometer, is above 10 (harder than a baby molar stick), preferably 15 to 40, and more preferably 20 to 30. Therefore, the plastic near the bone conduction vibrator is thickened, so that a thickness of the holding portion 21 around the bone conduction vibrator is larger than a thickness of other parts of the holding portion 21. It should be noted that, although the holding portion 21 has different thicknesses, the holding portion may be formed at one time. The expansion portion 24 enables a consumer to continue to chew the expansion portion 24 to implement sound playback after eating the small volume of candy body 30′ (for example, a thin layer of candy body). Therefore, the expansion portion 24 is in close contact with the entire bone conduction vibrator (that is, there is no cavity around the bone conduction vibrator), and the material of the holding portion 21′ is a hard material that is harmless to the human body and does not damage the teeth.

Further, since the material of the holding portion 21′ is harmless to the human body, does not damage the teeth, and is chewable, even if the consumer melts the candy body 30′ completely, and still chews the expansion portion 24 for a long time, the expansion portion 24 does not change (that is, does not break due to chewing).

In addition, an outer diameter of the expansion portion 24 is a size suitable for oral chewing, for example, an interdental distance between upper and lower molars of an adult when the oral cavity is slightly opened. This allows the consumer to chew the expansion portion 24 with the most comfortable feeling.

More preferably, since the expansion portion 24 can endure chewing for a longer time (more chewy than a candy body of the same volume), a large-capacity power supply needs to be provided to implement sound playback for a long time. Therefore, the volume of the power supply compartment needs to be increased (that is, a plurality of power supply compartments are arranged in the accommodating cavity); or a power supply with a higher energy density is selected; or a CR2025 button power supply (thinner) is replaced with a CR2032 button power supply (thicker) with a larger capacity. Due to different power supply thicknesses, power supply compartments of different specifications are required. Therefore, the two power supply compartments 220 in the accommodating cavity of the bone conduction vibration sounding candy provided in the present invention have different specifications to be suitable for different power supplies. For example, one power supply compartment is configured to install the CR2032 power supply, and the other is configured to install the CR2025 power supply. In addition, the power supply compartments are independent of each other and are not connected in series. In actual use, a suitable power supply (for example, CR2025) is selected according to a required playback duration and put in a corresponding power supply compartment. In this way, the bone conduction vibration sounding candy with a adjustable playback duration is realized at low costs.

### Third Embodiment

A bone conduction vibration sounding candy provided in this embodiment has an expansion portion 24, whose outer diameter is smaller than that of the expansion portion 24 described in the second embodiment, and which has the large-volume candy body described in the first embodiment. However, the outer diameter of the candy body is limited to being suitable for being completely put into the oral cavity.

Such a design does not reduce the sugar intake, but is suitable for a scenario of playback for a long time. Playback for a long time, for example, 2 hours, requires a candy body with a large volume. However, the volume of the candy body is limited by the size of the oral cavity. Therefore, the two requirements need to be balanced. After the candy body melts, the playback of the remaining time needs to be maintained through chewing of the expansion portion 24.

### Fourth Embodiment

A candy body of the bone conduction vibration sounding candy provided in this embodiment is made of a sugar-free food material, to be suitable for consumers with high blood sugar.

To sum up, the bone conduction vibration sounding candy, the sounding control method, and the sounding control system provided in the present invention have the following beneficial effects:
(1) A variety of readable music files are pre-stored in the system end 10, which is only used as a medium for the bone conduction playback end 20 to obtain the readable sound file, and does not interfere with the music playback of the bone conduction playback end 20. Moreover, the variety of readable music files can meet different requirements of users.
(2) Each bone conduction playback end 20 has a unique identification two-dimensional code 201, so that the identification two-dimensional code 201 can be used as a medium for rapid authentication and information transmission, and a plurality of bone conduction playback ends 20 can respectively obtain required readable sound files. That is, one system end 10 corresponds to a plurality of bone conduction playback ends 20, and the bone conduction playback ends 20 do not interfere with each other.
(3) The expansion portion 24 is arranged on the holding portion 21′. The material of the expansion portion 24 is a material that is harmless to the human body, does not damage the teeth, and is chewable. The sound playback can be implemented by chewing the expansion portion 24. Therefore, the consumer can reduce sugar intake, which is beneficial to body health.
(4) With the design of the expansion portion 24, the expansion portion 24 can withstand chewing for a long time (more chewy than the candy body of the same volume). Therefore, the plurality of power supply compartments 220 are arranged on the circuit control portion 22, so that power supplies of different capacities can be placed according to requirements, to implement sound playback for a long time or a short time, thereby meeting requirements of different consumers.

The bone conduction vibration sounding candy, the sounding control method, and the sounding control system provided in the present invention are described in detail above. For a person of ordinary skill in the art, any obvious modification made to the present invention without departing from the essence of the present invention constitutes an infringement of patent rights of the present invention, and a person of ordinary skill who make such modification shall bear corresponding legal liabilities.

What is claimed is:

1. A bone conduction vibration sounding candy, comprising:
a bone conduction playback end, having a unique identification two-dimensional code, for a system end to perform identification and transmit a preselected readable sound file according to an identification result for sound playback; and
a candy body, arranged on the bone conduction playback end for chewing.

2. The bone conduction vibration sounding candy according to claim 1, wherein the bone conduction playback end comprises:
a holding portion, wherein the unique identification two-dimensional code is arranged on the holding portion, and the holding portion has an accommodating cavity;
a circuit control portion, accommodated in the accommodating cavity and configured to be wirelessly connected to the system end, to receive the preselected readable sound file and convert the preselected readable sound file into an amplified analog sound signal; and
a bone conduction vibrator, connected to the circuit control portion through a wire and configured to output the amplified analog sound signal.

3. The bone conduction vibration sounding candy according to claim 1, wherein
the bone conduction vibrator is fixed in the holding portion and wrapped by the candy body; and
an end of the holding portion for fixing the bone conduction vibrator has a spherical or columnar expansion portion, and the expansion portion has a preset size to be suitable for oral chewing.

4. The bone conduction vibration sounding candy according to claim 3, wherein
a hardness of the expansion portion is more than 10 degrees Shore.

5. The bone conduction vibration sounding candy according to claim 3, wherein
an outer diameter of the expansion portion is a size suitable for oral chewing.

6. The bone conduction vibration sounding candy according to claim 1, wherein
the candy body is a sugar-free food or is a thin sugar-containing food with a thickness of 3 mm or less.

7. The bone conduction vibration sounding candy according to claim 2, wherein the circuit control portion comprises:
a control circuit board, accommodated in the accommodating cavity for circuit control;
an input portion, connected to the control circuit board and configured to be wirelessly connected to the system end, to receive the readable sound file;
a second read-write memory, connected to the control circuit board and the input portion, and configured to store the readable sound file;
a second decoding portion, connected to the control circuit board and the second read-write memory, and configured to decode the readable sound file into a digital audio file;
a digital-to-analog conversion portion, connected to the control circuit board and the second decoding portion, and configured to convert the digital audio file into an analog sound signal;
a power amplifier, connected to the control circuit board and the digital-to-analog conversion portion, and configured to amplify the analog sound signal; and
a power supply, connected to the control circuit board and configured to supply power to the control circuit board.

8. The bone conduction vibration sounding candy according to claim 2, wherein
the circuit control portion has adjustable power supply compartments for placing power supplies with different power levels, and the power levels are determined according to a duration of sound playback by the bone conduction playback end.

9. The bone conduction vibration sounding candy according to claim 8, wherein
the circuit control portion has a plurality of power supply compartments, the power supplies are placed in the power supply compartments, and the power supplies in the plurality of power supply compartments are connected in series or independent of each other.

10. The bone conduction vibration sounding candy according to claim 8, wherein
the plurality of power supply compartments have different sizes for respectively placing power supplies of different sizes.

11. A control method for bone conduction vibration sounding, implemented based on the bone conduction vibration sounding candy according to claim 1, the method comprising the following steps:
scanning a two-dimensional code sound file through a system end, to generate a readable sound file and store the readable sound file in the system end;
scanning a unique identification two-dimensional code on a bone conduction playback end through the system end, to transmit the selected readable sound file to the bone conduction playback end; and
receiving the readable sound file through the bone conduction playback end, and playing music after data conversion.

12. The control method according to claim 11, wherein the scanning a two-dimensional code sound file through a system end, to generate a readable sound file and store the readable sound file in the system end further comprises:
reading the two-dimensional code sound file through a two-dimensional code reading portion of the system end;
receiving the two-dimensional code sound file through a first read-write memory of the system end, and temporarily storing the two-dimensional code sound file in the first read-write memory;
obtaining the temporarily stored two-dimensional code sound file from the first read-write memory through a first decoding portion of the system end, to perform data decoding on the temporarily stored two-dimensional code sound file and generate the readable sound file;
feeding back the readable sound file to the first read-write memory through the first decoding portion; and
obtaining the readable sound file through a display portion of the system end, to display the readable sound file in a data list.

13. The control method according to claim 12, wherein the receiving the readable sound file through the bone conduction playback end, and playing music after data conversion further comprises:
receiving the readable sound file through an input portion of the bone conduction playback end;
obtaining, through a second read-write memory of the bone conduction playback end, the readable sound file sent by the input portion, and storing the readable sound file in the second read-write memory;
obtaining the readable sound file in the second read-write memory through a second decoding portion of the bone conduction playback end, and decoding the readable sound file into a digital audio file;
obtaining the digital audio file through a digital-to-analog conversion portion of the bone conduction playback end, and converting the digital audio file into an analog sound signal;
obtaining the analog sound signal through a power amplifier of the bone conduction playback end, and amplifying the analog sound signal; and
receiving the amplified analog sound signal through a bone conduction vibrator of the bone conduction playback end, and outputting the analog sound signal.

14. A bone conduction vibration sounding system, comprising:
a system end, configured to identify a two-dimensional code sound file, to generate a readable sound file and store the readable sound file in the system end;
a bone conduction playback end, having a unique identification two-dimensional code, for the system end to perform identification and transmit a preselected readable sound file according to an identification result for music playback; and
a candy body, arranged on the bone conduction playback end for chewing.

15. The bone conduction vibration sounding system according to claim 14, wherein
the bone conduction playback end comprises:
a holding portion, wherein the unique identification two-dimensional code is arranged on the holding portion, and the holding portion has an accommodating cavity;
a circuit control portion, accommodated in the accommodating cavity and configured to be wirelessly connected to the system end, to receive the preselected readable sound file and convert the preselected readable sound file into an amplified analog sound signal; and
a bone conduction vibrator, connected to the circuit control portion through a wire and configured to output the amplified analog sound signal.

16. The bone conduction vibration sounding system according to claim 15, wherein
the bone conduction vibrator is fixed in the holding portion and wrapped by the candy body; and
an end of the holding portion for fixing the bone conduction vibrator has a spherical or columnar expansion portion, and the expansion portion has a preset size to be suitable for oral chewing.

17. The bone conduction vibration sounding system according to claim 16, wherein
a hardness of the expansion portion is more than 10 degrees Shore.

18. The bone conduction vibration sounding system according to claim 16, wherein
an outer diameter of the expansion portion is a size suitable for oral chewing.

19. The bone conduction vibration sounding system according to claim 14, wherein
the candy body is a sugar-free food or is a thin sugar-containing food with a thickness of 3 mm or less.

20. The bone conduction vibration sounding system according to claim 14, wherein
the circuit control portion has adjustable power supply compartments for placing power supplies with different power levels, and the power levels are determined according to a duration of sound playback by the bone conduction playback end.
